(19) United States
(12) Patent Application Publication
(10) Pub. No.: US 2010/0188003 A1
(43) Pub. Date: Jul. 29, 2010

(54) Electronic device, a control system and a method of controlling a light-emitting element thereof

(75) Inventor: Yu-Hsien Ku, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/457,305

(22) Filed: Jun. 8, 2009

(30) Foreign Application Priority Data
Jan. 23, 2009 (TW) 098102794

(51) Int. Cl. H05B 37/02

(52) U.S. Cl. 315/149; 315/307; 315/292

(57) ABSTRACT

A control system and a method of controlling a light-emitting element thereof are disclosed. The control system is used to adjust a light-emitting element of an electronic device. The control system comprises a control module, a signal input module, and a signal output module. The signal output module has a register. The signal input module and the signal output module are electrically connected to the control module. The method of controlling the light-emitting element comprises the follow steps: determining whether there is a signal inputted by means of the control system; if the signal is detected, adjusting the setting of the register according to the signal; generating a control signal; and adjusting the brightness level of the light-emitting element according to the control signal.

### BACKGROUND OF THE INVENTION

1. Field of the Invention

The invention relates to a control system and method thereof, and more particularly to a system and method which can adjust the brightness level of light-emitting elements of an electronic device.

2. Description of the Related Art

With advancement of technology, electronic devices such as notebook computers are prevalent nowadays. Besides the functionalities of notebook computers, aesthetics is also one major selection criteria when users are choosing a notebook computer. With these computers, light emitting diodes (LEDs) are commonly used to indicate system status by displaying as either “on” or “off”. For example, the LEDs are used to indicate the status of a battery life or a wireless network. In addition, some notebook computers incorporate LEDs for decorative purposes.

However, the LED indicators of notebook computers may cause disturbances in some situations. For example, the LED that is too bright may cause visual irritation to the user or to others during a conference meeting, or during a flight in a cabin. In the prior art, users cannot adjust the brightness level of the LEDs indicators; these LEDs can merely be switched as on or off, and switching off the LEDs prevents the user from obtaining important information such as the status of battery life or wireless network.

Therefore, a new control system is needed to resolve the problems of the prior art.

### SUMMARY OF THE INVENTION

One objective of the invention is to provide a control system and a method thereof, which is able to adjust the brightness level of a light-emitting element.

Another objective of the invention is to provide an electronic device which has a light-emitting element brightness control system.

To achieve the above mentioned objectives, the electronic device of the invention comprises a light-emitting element and a control system. The control system is used to control the light-emitting element. The control system comprises a control module, a signal input module, and a signal output module. The signal input module is electrically connected to the control module for inputting a signal. The signal output module has a register and is electrically connected to the control module for generating a control signal. After the signal is inputted through the signal input module, the control module will adjust the setting of the register according to the signal received; the control module then controls the signal output module to generate the control signal for adjusting the brightness level of the light-emitting element.

The method of controlling the light-emitting element of the invention comprises the follow steps: determining whether there is a signal inputted by means of the control system; if the signal is detected, adjusting the settings of a register according to the signal received; generating a control signal; and adjusting the brightness level of the light-emitting element according to the control signal.

### BRIEF DESCRIPTION OF THE DRAWINGS

FIG. 1A shows an external view of the electronic device for the invention.

FIG. 1B shows an internal structure of the electronic device for the invention.

FIG. 2 shows a flow chart of the first embodiment of the control system for controlling the light-emitting element in accordance with the invention.

FIG. 3 shows a flow chart of the second embodiment of the control system for controlling the light-emitting element in accordance with the invention.

### DETAILED DESCRIPTION OF THE PREFERRED EMBODIMENT

The advantages and innovative features of the invention will become more apparent from the following preferred embodiments.

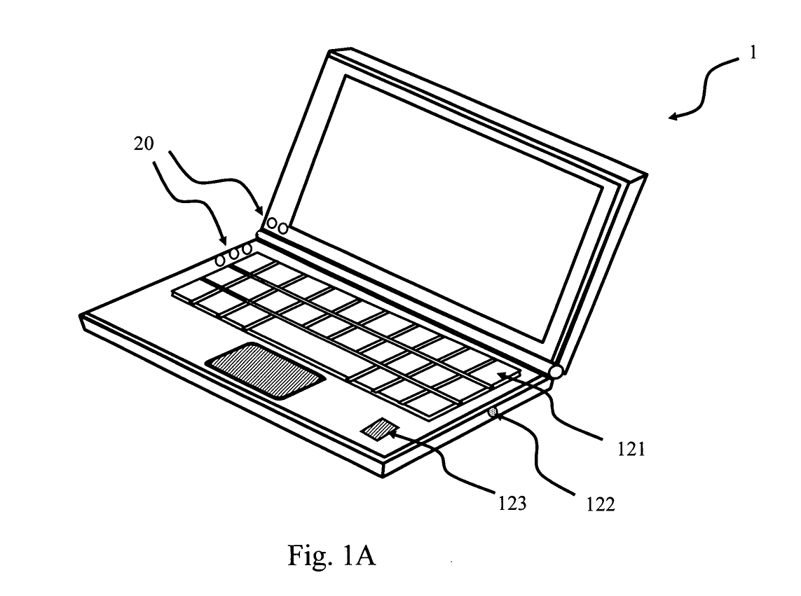

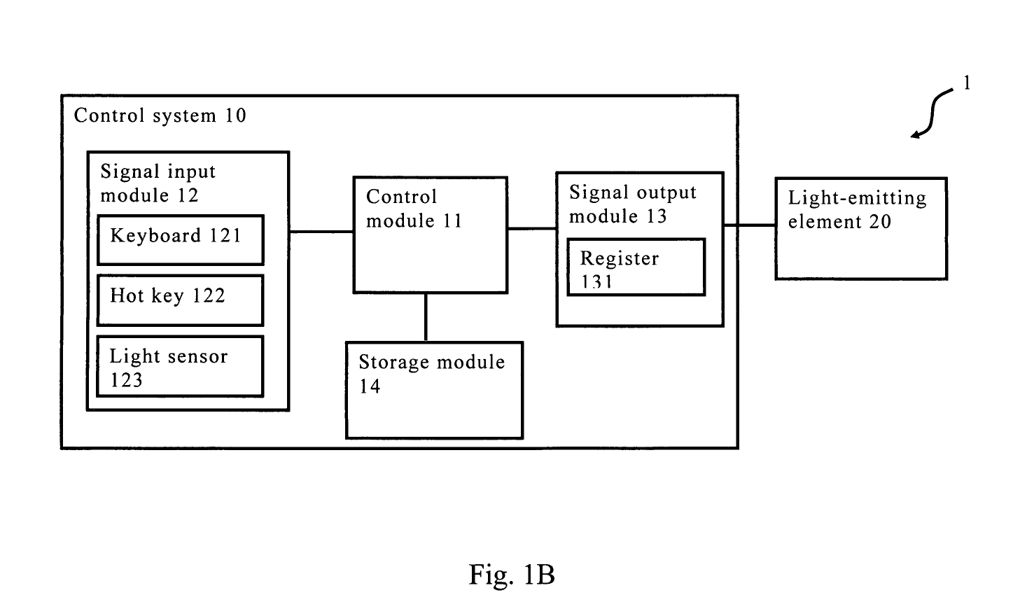

Please refer to FIG. 1A and FIG. 1B simultaneously. FIG. 1A shows an external view of the electronic device for the invention. FIG. 1B shows an internal structure of the electronic device for the invention.

Although the embodiments of the invention are illustrated using a notebook computer, the electronic device 1 can be a notebook computer or a mobile phone, but the invention is not only limited to these devices. The electronic device 1 comprises a control system 10 and a light-emitting element 20. The control system 10 of the invention is disposed within the electronic device 1 for controlling the light-emitting element 20 of the electronic device 1. The light-emitting element 20 can be an LED, a small tungsten bulb or any other element which has light-emitting materials. The electronic device 1 is not limited to having a single light-emitting element 20 only; it can also have multiples of light-emitting elements 20.

The control system 10 comprises a control module 11, a signal input module 12, a signal output module 13 and a storage module 14, and these modules are electrically connected to each other. The control module 11 can be an embedded controller (EC). The control module 11 controls the signal output module 13 by means of the signal inputted by the signal input module 12; details of the controlling method will be described in a later section. The signal input module 12 is used for inputting a signal to the control module 11. The signal input module 12 can be a keyboard 121, a hot key 122 or a light sensor 123. The keyboard 121 allows the user to enter a command with a key or a combination of keys; the hot key 122 can be a key, a physical button, a turning knob or a touch button; the light sensor 123 is used to detect the brightness of the light source in the surrounding environment. Take note that the signal input module 12 can comprise the keyboard 121, the hot key 122 and the light sensor 123 concurrently, or comprise just one of these components.

The signal output module 13 can be a Pulse Width Modulation (PWM) module or a voltage output module. The signal output module 13 comprises a register 131. The PWM module is used to generate pulse width-modulated signals. By adjusting the settings of the register 131 of the PWM module, the PWM module is able to generate pulse width-modulated signals with various pulse widths to control the brightness level of the light-emitting element 20. Take an 8-bit PWM module as an example; the control module 11 can control one of the pins of the PWM module. Therefore, the brightness range of the light-emitting element 20 is divided into 256 levels, from the brightest state to the off-state. On the other hand, the voltage output module uses a voltage signal to control the brightness level of the light-emitting element 20. The brightness level of the light-emitting element 20 will increase as the voltage of the voltage signal increases. Take note that the signal used to control the light-emitting element 20 is not limited to the abovementioned PWM and voltage signals.

The control system 10 further comprises a storage module 14, which is used for storing application programs. The control module 11 is able to separately control a single light-emitting element 20 or multiples of light-emitting elements 20 by executing the application program along with the circuit layout of the signal output module 13. When the control module 11 needs to control multiples of light-emitting elements 20, the application program is executed to determine the controlling method of each light-emitting element 20, and then the signal output module 13 will send different controlling signals to control each light-emitting element 20 separately.

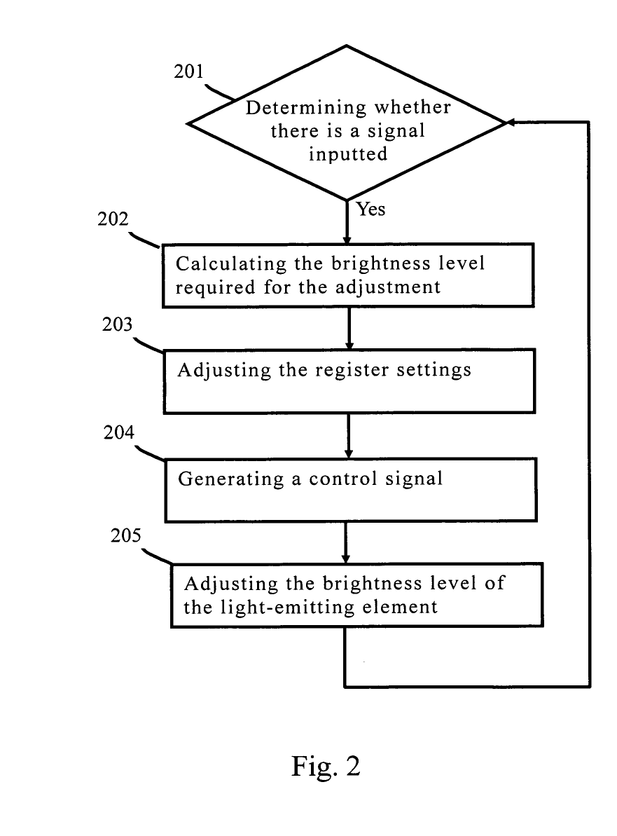

Next, please refer to FIG. 2. FIG. 2 shows a flow chart of the first embodiment of the control system 10 for controlling the light-emitting element 20 in accordance with the invention. Take note that although the light-emitting element controlling method is illustrated using the electronic device 1 along with the control system 10, the light-emitting element controlling method is by no means restricted to usage only with the control system 10.

In the first embodiment of the invention, the signal input module 12 is demonstrated by means of a key.

First proceed with step 201: determining whether there is a signal inputted.

The control module 11 first determines whether a single key or a combination of keys is pressed on the keyboard 121 by means of a keyboard matrix scanning method. The control module 11 can also determine whether the signal is coming from a general purpose I/O (GPIO) module (not shown) entered by the hot key 122. There will be no further discussion on either the keyboard matrix scanning method or the GPIO module method, as these methods are commonly used in the prior art. A signal is sent to the control module 11 when the key on the keyboard 121 or the hot key 122 is pressed.

Take note that the invention is able to generate various signals from a keyboard having multiple keys or buttons; a signal can be sent by pressing a single key stroke, a combination of keys, a button, or the hot key 122. Different signals can also be generated by pressing the key or button a certain number of times.

When the key or button for controlling the light-emitting element 20 is pressed, proceeds to step 202: calculating the brightness level required for the adjustment.

According to the signal obtained from step 201, the control module 11 calculates the brightness level of adjustment which is required by the light-emitting element 20. For example, the percentage in terms of brightness level for adjusting the light-emitting element 20 can be calculated.

Next, proceed to step 203: adjusting the register settings.

The control module 11 will adjust the register 131 of the signal output module 13 according to the adjustment value obtained from step 202. For example, the duty cycle of the register 131 is adjusted such that the PWM module can generate pulse width-modulated signals which are required to control the light-emitting element 20. In another example, the settings of the register 131 can be altered to change the voltage signal of the voltage output module.

Next, proceed with step 204: generating a control signal.

The control module 11 will adjust the settings of the register 131 as mentioned in step 203 to control the signal output module 13 for generating control signals, which means generating the pulse width-modulated signals or the voltage signals.

Finally, proceed with step 205: adjusting the brightness level of the light-emitting element 20.

The control signal generated by the signal output module 13 adjusts the brightness level of the light-emitting element 20. Furthermore, the control module 11 can adjust the brightness level of a single light-emitting element 20 or a multiple of light-emitting elements 20 by means of an application program.

After step 205 is completed, the control system 10 can repeat step 201 to wait another input signal for controlling light-emitting element 20.

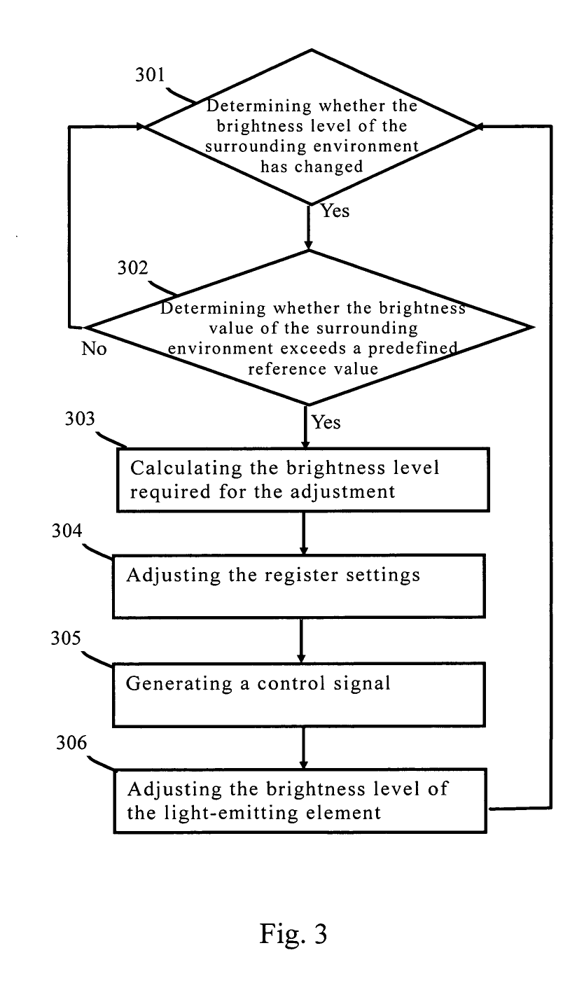

Next, please refer to FIG. 3. FIG. 3 shows a flow chart of the second embodiment of the control system 10 for controlling the light-emitting element 20 in accordance with the invention.

In the second embodiment of the invention, the signal input module 12 is illustrated by means of a light sensor 123.

First proceed with step 301: determining whether the brightness level of the surrounding environment has changed.

To begin with, the light sensor 123 is used to detect the brightness level of the surrounding environment. If a change of the brightness is sensed, then proceed with step 302.

Step 302: determining whether the brightness value of the surrounding environment exceeds a reference value.

At this time, the control module 11 compares the brightness value of the surrounding environment with a predefined reference value. The reference value is predefined by the control module 11 in order to distinguish the brightness level in the surrounding environment. When the reference value is exceeded, it means that the brightness of the surrounding environment has surpassed or fallen below the corresponding brightness range of the light-emitting element 20. Therefore, the light sensor 123 will send out a signal and proceed to step 303.

If the brightness value falls within the reference value, return to step 301.

If the brightness value exceeds the reference value, then proceed to step 303: calculating the brightness level for the adjustment.

By means of the signal obtained from the light sensor 123, the control module 11 is able to calculate the brightness level required by the light-emitting element 20 in order to correspond to the brightness level of the surrounding environment. The percentage in terms of the brightness level for adjusting the light-emitting element 20 can be determined.

Next, proceed to step 304: adjusting the register settings.

The control module 11 will adjust the register 131 of the signal output module 13 according to the adjustment value obtained from step 303. Therefore the PWM module or the voltage output module can be adjusted accordingly. This step is processed in the same way as step 203 and will not be further explained.

Next, proceed with step 305: generating a control signal.

The control module 11 will adjust the settings of the register 131 as mentioned in step 304 to control the output signal module 13 for generating the control signals, which means generating the pulse width-modulated signals or the voltage signals.

Finally proceed with step 306: adjusting the brightness level of the light-emitting element.

The control signal generated by signal output module 13 adjusts the brightness level of the light-emitting element 20, such that its brightness corresponds to the brightness of the surrounding environment.

Next, the control system 10 repeats step 301 so that the light-emitting element 20 can change its brightness level under any surrounding light sources accordingly.

Take note that the step of the light-emitting element controlling method of the control system is not restricted to the abovementioned sequence. The order of the steps can be modified as long as the objectives of the invention are attained.

The invention can also combine the processes of the first embodiment and the second embodiment. For example, when the light-emitting element 20 changes its brightness level according to the surrounding environment detected by the light sensor 123, the user can also adjust the brightness level of the light-emitting element 20 by means of the keyboard 121 or the hot key 122, wherein the priority of the adjustment process can be determined by the application program.

Therefore, the electronic device 1 can adjust the brightness level of the light-emitting element 20, and it is no longer limited to merely being switched on and off.

Although the invention has been explained in relation to its preferred embodiment, it is also of vital importance to acknowledge that many other possible modifications and variations can be made without departing from the spirit and scope of the invention as hereinafter claimed.

What is claimed is:

1. An electronic device comprising:
a light-emitting element; and
a control system used for controlling the light-emitting element,
wherein the control system comprises:
a control module;
a signal input module which is electrically connected with the control module for inputting a signal; and
a signal output module which is electrically connected with the control module for generating a control signal; after the signal is inputted by the signal input module, the control module then controls the signal output module to generate the control signal for adjusting brightness level of the light-emitting element.

2. The electronic device as claimed in claim 1, wherein the signal input module is a keyboard, which uses a single key or a combination of keys for generating the input signal.

3. The electronic device as claimed in claim 1, wherein the signal input module is a hot key for generating the input signal, and the hot key is a key, physical button, a turning knob or a touch button;.

4. The electronic device as claimed in claim 1, wherein the signal input module is a light sensor.

5. The electronic device as claimed in claim 1, wherein the signal output module comprises a register.

6. The electronic device as claimed in claim 1, wherein the signal output module is a Pulse Width Modulation (PWM) module used for generating a pulse width-modulated signal to adjust the brightness level of the light-emitting element.

7. The electronic device as claimed in claim 1, wherein the signal output module is a voltage output module used for generating a voltage signal to adjust the brightness level of the light-emitting element.

8. The electronic device as claimed in claim 1 further comprising a storage module for storing an application program, wherein the application program is used by the control module to control the light-emitting element.

9. A control system for controlling a light-emitting element, wherein the control system comprises:
a control module;
a signal input module which is electrically connected with the control module for inputting a signal; and
a signal output module which is electrically connected with the control module for generating a control signal; after the signal is inputted by the signal input module, the control module then controls the signal output module to generate the control signal for adjusting brightness level s of the light-emitting element.

10. The control system as claimed in claim 9, wherein the signal input module is a key, a combination of keys, a hot key or a light sensor for generating the input signal.

11. The control system as claimed in claim 9, wherein the signal output module comprises a register.

12. The control system as claimed in claim 9, wherein the signal output module is a Pulse Width Modulation (PWM) module used for generating a pulse width-modulated signal to adjust the brightness level of the light-emitting element.

13. The control system as claimed in claim 9, wherein the signal output module is a voltage output module used for generating a voltage signal to adjust the brightness level of the light-emitting element.

14. The control system as claimed in claim 9 further comprising a storage module for storing an application program, wherein the application program is used by the control module to control the light-emitting element.

15. A method for controlling a light-emitting element, which is used by a control system to control a light-emitting element, the method comprising the following steps:
determining whether there is a signal inputted by means of the control system;
if the signal is detected, then generating a control signal; and
adjusting brightness level of the light-emitting element according to the control signal.

16. The method for controlling the light-emitting element as claimed in claim 15, wherein the process of determining whether there is the signal inputted comprises the steps of:
using a light sensor to determine whether the brightness level of the surrounding environment has changed; and
determining whether the brightness value of the surrounding environment exceeds a predefined reference value and therefore input the signal.

17. The method for controlling the light-emitting element as claimed in claim 15, wherein the step of determining whether there is the signal inputted further comprises the step of determining whether the signal is inputted by a key or a combination of keys.

18. The method for controlling the light-emitting element as claimed in claim 15, wherein the step of determining whether there is the signal inputted further comprises the step of determining whether the signal is inputted by a hot key.

19. The method for controlling the light-emitting element as claimed in claim 15, further comprising the step of calculating the brightness level required for adjusting the light-emitting element.

20. The method for controlling the light-emitting element as claimed in claim 15, further comprising the step of controlling the light-emitting element by means of an application program.
